(19) United States
(12) Patent Application Publication
(10) Pub. No.: US 2018/0356776 A1
(43) Pub. Date: Dec. 13, 2018

(54) REWARD MECHANISM FOR EFFICIENT ENERGY DISTRIBUTION ACROSS VARIOUS CUSTOMER SCENARIOS

(71) Applicant: International Business Machines Corporation, Armonk, NY (US)

(72) Inventors: Harish Bharti, PUNE (IN); Abhay K. Patra, PUNE (IN); Pranshu Tiwari, NEW DELHI (IN); Saurabh Trehan, DELHI (IN)

(21) Appl. No.: 15/616,265

(22) Filed: Jun. 7, 2017

(51) Int. Cl. G05B 15/02

(52) U.S. Cl. CPC G05B 15/02

(57) ABSTRACT

A method, system and computer program product are disclosed for rewarding customers for sustained energy conservation. In embodiments of the invention, the method comprises establishing a baseline of energy consumption for a customer; defining a rewards program; and determining a reward for the customer, based on the rewards program, for maintaining the customer's energy utilization in a given range compared to the baseline. In embodiments of the invention, the system comprises one or more processing units configured to operate as a file server for receiving specified energy consumption data from customers, and a business analytical engine. The business analytical engine stores a defined rewards program; establishes a baseline of energy consumption for one of the customers; and determines a reward for the one customer, based on the rewards program, for maintaining the one customer's energy utilization in a given range compared to the baseline.

### BACKGROUND

This invention, generally, relates to energy conservation, and more specifically, to motivating energy consumers to use energy more efficiently.

While there have been many developments in carbon credits and energy savings in energy distribution space, there is no compelling reason for consumers to save energy or to optimize their energy use. An important reason for this is that there is no unified framework for customers to trade energy savings or to optimize carbon credits in this space.

Further to this, most energy suppliers/energy distribution companies are interested in energy saving/carbon credits if and only if the suppliers and distribution companies are driven by regulatory compliance.

### SUMMARY

Embodiments of the invention provide a method, system and computer program product for rewarding customers for sustained energy conservation. In embodiments of the invention, the method comprises establishing a baseline of energy consumption for a customer based on energy consumption of the customer over a given period of time; defining a rewards program for energy conservation; and determining a reward for the customer, based on the defined rewards program, for maintaining the customer's energy utilization, over a defined time duration after said given period of time, in a given range compared to said baseline of energy consumption.

In embodiments of the invention, the establishing a baseline of energy consumption is done after an energy audit is performed of the customer's energy use.

In embodiments of the invention, the energy audit is performed by an energy distribution utility that distributes energy to the customer.

In embodiments of the invention, the customer has the energy audit performed.

In embodiments of the invention, the system comprises a memory for storing data; and one or more processing units operatively connected to the memory and configured to operate as a file server and a business intelligence analytical engine. The file server is for receiving specified energy consumption data from customers. The business intelligence analytical engine stores a defined rewards program for energy conservation; establishes a baseline of energy consumption for one of the customers over a given period of time; and determines a reward for the one customer, based on the defined rewards program, for maintaining the one customer's energy utilization, over a defined time duration after said given period of time, in a given range compared to said baseline of energy consumption.

Embodiments of the invention provide a unified framework and methodology which will motivate customers to increase energy savings and to collaborate with energy distribution utilities to help achieve a more stable and reliable power distribution.

Embodiments of the invention motivate customers to save energy by awarding points for reducing their energy consumption across different use cases. These different use cases include awarding customers when they buy new equipment.

### BRIEF DESCRIPTION OF THE SEVERAL VIEWS OF THE DRAWINGS

FIG. 1 is a chart showing the operation of an embodiment of this invention.

FIG. 2 is a graph illustrating a customer's energy consumption over a period of time.

FIG. 3 shows an illustrative reward points table that may be used in embodiments of the invention.

FIG. 4 is an illustrative table that shows the motivation level of various rewards.

FIG. 5 is a table that shows different levels of a reward program in an embodiment of the invention.

FIG. 6 illustrates energy consumption patterns for three groups of customers.

FIG. 7 is a table that shows several states of a customer.

FIG. 8 shows an architecture for a system in accordance with an embodiment of the invention.

FIG. 9 illustrates a computer network environment that may be used in embodiments of the invention.

### DETAILED DESCRIPTION

While there have been many developments in carbon credits and energy savings in energy distribution space, there is no compelling reason for consumers to save energy or to optimize their energy use. An important reason for this is that there is no unified framework for customers to trade energy savings or to optimize carbon credits in this space.

Further to this, most energy suppliers/energy distribution companies are interested in energy saving/carbon credits if and only if the suppliers and distribution companies are driven by regulatory compliance. Hence, there is an intrinsic need for a unified framework and methodology which will motivate customers to increase energy savings and to collaborate with energy distribution utilities to help achieve a more stable and reliable power distribution.

Embodiments of the invention motivate customers to save energy by awarding points for reducing their energy consumption across different use cases. These different use cases include cases in which the customers purchase or use additional equipment, and cases in which there is a sudden increase, or spike, in energy consumption compared to a historical average.

Embodiments of the invention provide a pragmatic and comprehensive model for motivating consumers to continuously optimize energy consumption with a quantitative reward mechanism.

In embodiments of the invention, the model is robust and progressive to ensure that consumers focus on energy consumption optimization even after an undesired spike in the use of energy, to bring back optimized energy consumption. (This may be done by considering a historical average energy consumption over a given time period with a 15% tolerance limit. Additionally, outlier data may be removed from the analysis.)

In embodiments of the invention, the model realistically motivates consumers to stay with an optimum utilization of energy by rewarding consumers for maintaining that optimum utilization, and not just for achieving that optimization. (In embodiments of the invention, this is achieved by ANOVA testing and Finite Markov prediction.)

In embodiments of the invention, the framework considers all of the following scenarios:
1. The consumer has an energy audit performed as and when needed, and the consumer does not get any additional equipment after the energy audit;
2. The consumer has an energy audit performed during a window period set by an energy distribution utility;
3. The consumer has an energy audit performed as in either of the above-discussed scenarios (1) or (2), and buys new equipment after the energy audit;
4. The consumer does not have an energy audit performed, but yet has lower energy consumption as compared to a historical average; and
5. The utility awards points to the consumer as long as the utility's energy audit campaign is effectively reducing energy consumption of the customer as compared to a control group.

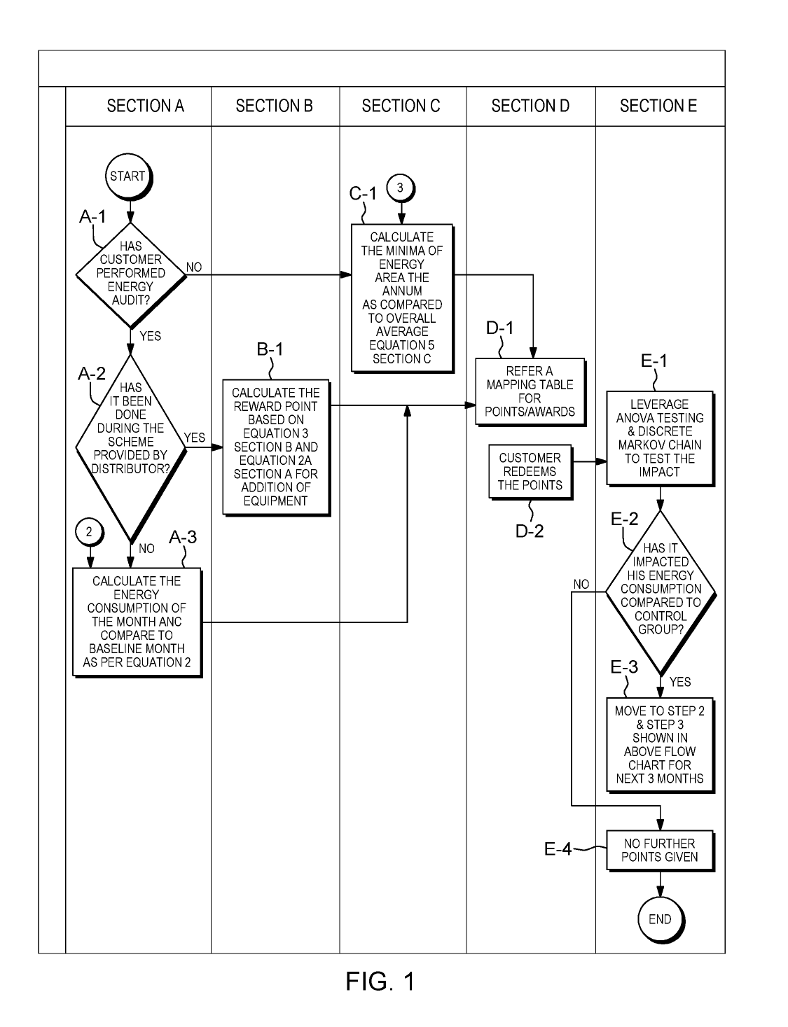

The chart of FIG. 1 shows the flow of a process to award points to the consumer, either on the basis of energy saved, or on the basis of reporting hazardous activity. FIG. 1 shows five sections:
A. The consumer has an energy audit performed at the time of his own preference or choosing—i.e., when the energy distribution utility is not running an energy audit campaign on improving energy efficiency;
B. The customer has an energy audit performed during the time the energy distribution utility is running a campaign to optimize energy savings;
C. The customer saves energy, without an energy audit, by virtue of reducing electricity consumption;
D. Point redemption; and
E. ANOVA and Markov testing.

Generally, step A-1 is to determine whether the customer has had an energy audit performed. If the customer has not had an audit performed, the method proceeds to C-1, discussed below. If the customer has had an energy audit performed, the method goes to A-2. Step A-2 is to determine whether the audit was conducted during an audit campaign of the energy distribution utility. If so, the method goes to B-1; and if not, the method proceeds to A-3. Step A-3 is to calculate the energy consumption of the customer during a particular month, and to compare this consumption to a baseline month, as for example by using equation (2) below. From step A-3, the method proceeds to D-1, discussed below.

Step B-1 is to calculate the reward points. This is done in different ways depending on the customers' circumstances. For instance, the reward points may be determined using equation (3) below. Equation (2), also discussed below, may be used if the customer has added equipment after the energy audit. From B-1, the method also proceeds to D-1.

Step C-1 is to calculate the minima of energy consumption by the customer for a given length of time in a given year, and to compare that minima to an overall average. This may be done using equation (5) below. From step C-1, the method goes to D-1.

At D-1, a table is used to determine the reward points for the customer. At D-2, the customer redeems the reward points, and from D-2, the process proceeds to E-1.

As represented at E-1, embodiments of the invention leverage ANOVA testing and discrete Markov Chain to test the impact of the rewards system. E-2 is to determine if the reward system has impacted the customer's energy consumption compared to a control group. If the reward system has impacted the customer's energy consumption, the method, as represented at E-3, returns to A-3 or C-1, and proceeds from there to evaluate the customer's energy consumption and to determine if the customer deserves reward points for the next period of time. If, at E-2, it is determined that the reward system has not impacted the customer's energy consumption, the customer is not given any further points, as represented at E-4, and the process ends.

Each of these sections (A)—(E) is discussed further below.

Section (A)—Energy audit/efficiency of premises when the customer has the energy audit performed outside the energy audit window provided by the energy distribution utility.

In a first case, Case A, the customer has the energy audit done to improve the customer's power efficiency/improve EPC rating (UK)/energy category (India/US). In this case, no reward points are given immediately to the customer. In embodiments of the invention, reward points can be given on a monthly basis.

The following notation is used in this discussion:
V—the voltage at the customer's premise; this voltage is also referred to as the phase to neutral voltage (Vpn);
I—an initial current drawn at the customer's premise with the voltage at Vpn, and with a power factor (cos Φ);
t—the time duration of electricity consumption of all the equipment at the customer's premise;
P—power of the energy used at the customer's premise; and
e—energy consumed at the customer's premise.
   Some utilities do not consider the power factor for billing. In that case, energy consumed (e)=total power used at the consumer's premise (P)×time of the energy consumption (t). In that case, equation (2) below will have time as a variable.

Since P=V*I*cos Φ, and energy consumed (c)=P*t, hence energy consumed is a function of I, cos Φ, and t (as V is constant). This can be expressed as:

Energy Consumed=f(I, cos Φ,t)V Equation (1).

After an energy audit, the power factor and the current drawn by all the equipment at the customer's premise change. The new power factor is represented as cos Φ′, the new current drawn at the customer's premise is represented as I′, and the new energy consumed is e′.

Hence, after the audit, the new energy consumed

(e′)=V(I′*cos Φ′*t′)

where t′ is the duration of time of electricity consumption of all the equipment of the customer after the audit. For simplicity in this equation, the variation in energy consumption is considered from a baseline month.

In embodiments of the invention, the customer may be a business, and the customer's premise may be, for instance, a factory, an office, an office building, or a warehouse. In embodiments of the invention, the customer may be a person, and the customers premise may be, for example, a house or other residence.

In the following example, a customer consumes energy and receives a bill for the energy consumption on a monthly period.

Let eo be the energy consumed by the customer during a first month after the audit for which the customer is billed. This will be considered the baseline energy consumption.

In embodiments of the invention, the tolerance limit is up to 15% of the energy consumed during that first month. In embodiments of the invention, this tolerance limit may be increased or customized depending on the season/time of the year.

For energy consumption after that first month, reward points may be awarded according to the following formula:

$$Reward Points R ( for month n ) = \{ \begin{matrix}0 \text{:} {e}^{′} > eo + 0.15 eo \\ β \text{:} {e}^{′} < eo + 0.15 eo \\ 2 β \text{:} {e}^{′} < eo\end{matrix} \} \qquad Equation ( 2 )$$

β is the number of reward points earned if the customer does not increase his energy consumption (eo) (assuming that no new equipment is added to the customer's premise).

As mentioned above, some utilities do not consider the power factor for billing.

Hence, after the energy audit, the customer will get reward points only if e′≤eo+0.15eo. This means that after the energy audit, the customer will get points if he does not increase the energy consumption after the first month for which the customer is billed after the energy audit.

In embodiments of the invention, this algorithm will motivate the customer to not increase his energy consumption after the energy audit by increasing the length of time of electricity consumption during a period of the year in comparison with the same period of the previous year.

In case the customer buys new equipment, the threshold to determine whether points can be awarded can be increased to 0.25eo. Hence, points will be rewaarded if e′<eo+0.15eo.

Section (B)

Case B—The energy distributor initially decides to give reward points during an energy audit campaign, i.e., there is a new power factor or new category or new EPC. The energy consumed can be determined using equation (1). However, unlike case A discussed above, in case B, the customer gets some reward points at the time of the energy audit. After the initial points are credited to the customer, the reward points (R(t)) given at a subsequent time (t) are credited as per the following:

$$R ( t ) = \\ \{ \begin{matrix}μ \text{:} ( at t = 0 ) ( Points awarded when the energy audit \\ was initiated , \\ n β \text{:} where n equals the number of periods in which \\ {e}^{′} < eo + 0.15 eo\end{matrix} \qquad Equation ( 3 )$$

Section (C)

Case C—The reward points are awarded two years after an energy audit, or, in case the customer does not have an energy audit performed but decreases his energy consumption without the audit, two years after the customer decreases his energy consumption.

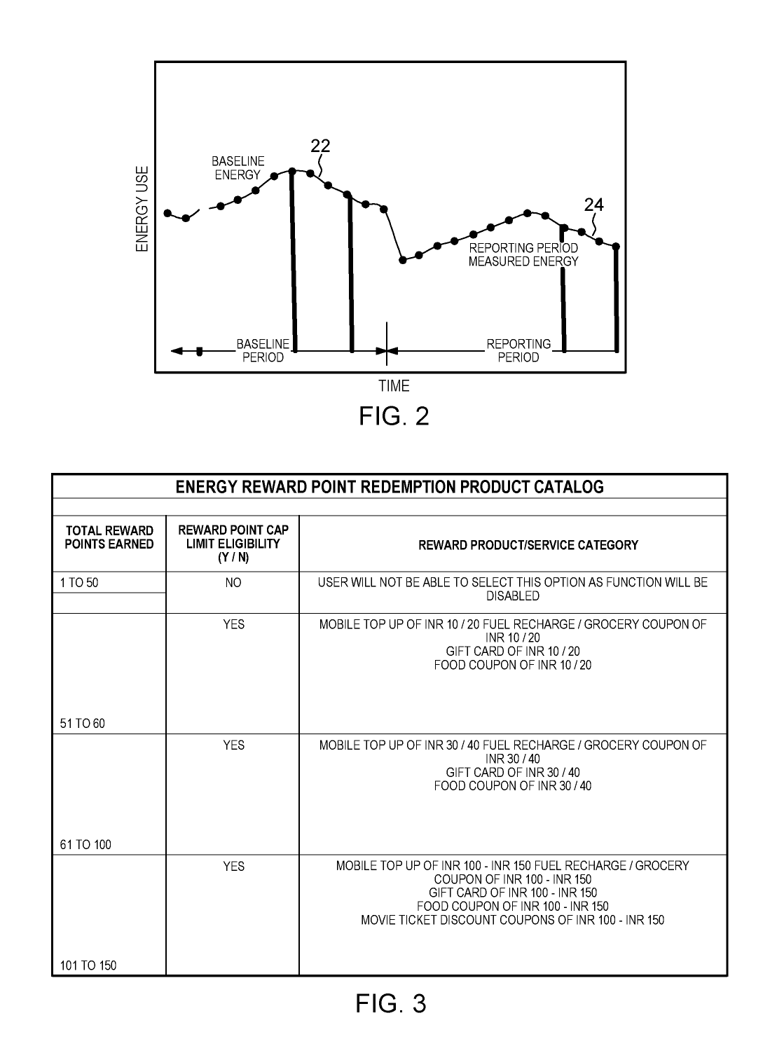

FIG. 2 shows, as an example, the energy consumption of a customer over a length of time. At 22 and 24, this FIG. shows the energy consumption during the same time period—such as the same month, or the same three month period—of two years.

In this example,

Energy Consumed=∫_{Q}^{T}e(t)·dt Equation (4),

for any period of the year.

In embodiments of the invention, since saving electricity will directly result in savings to the customer, there is no reason to give reward points based on a comparison of the baseline energy consumption of a customer over a particular period (such as a specific month or season) to historical data for the same period.

In embodiments of the invention, reward points should be given if and only if the energy consumed is a minima for an entire historical of time of, for example, three years. Hence, in this case, reward points will be given only if the customer's energy consumption is minimal for any three month period across the historical time of three years.

This can be expressed as follows:

$$R ( t ) = \{ \begin{matrix}ɛ if d \text{/} dt ( {\int }_{0}^{t ′} E ( t ) . dt = 0 \& \frac{d 2}{dt 2} > 0 \\ 0\end{matrix} \qquad Equation ( 5 )$$

where ε is the number of reward points given if the energy consumption is below the minimum during t′ month period for a historical time of up to three years.
In this example, t′ is a three month period.

Since the reward points are minimal and the frequency of the award is once a year (compared to the historical three year period), the reward program motivates the customer to perform an energy audit, or to improve the power efficiency or EPC rating for the customer's premise.

Section (D)

FIG. 3 shows a table that lists products and services given for different reward point levels. The motivation level of the product catalog is high.

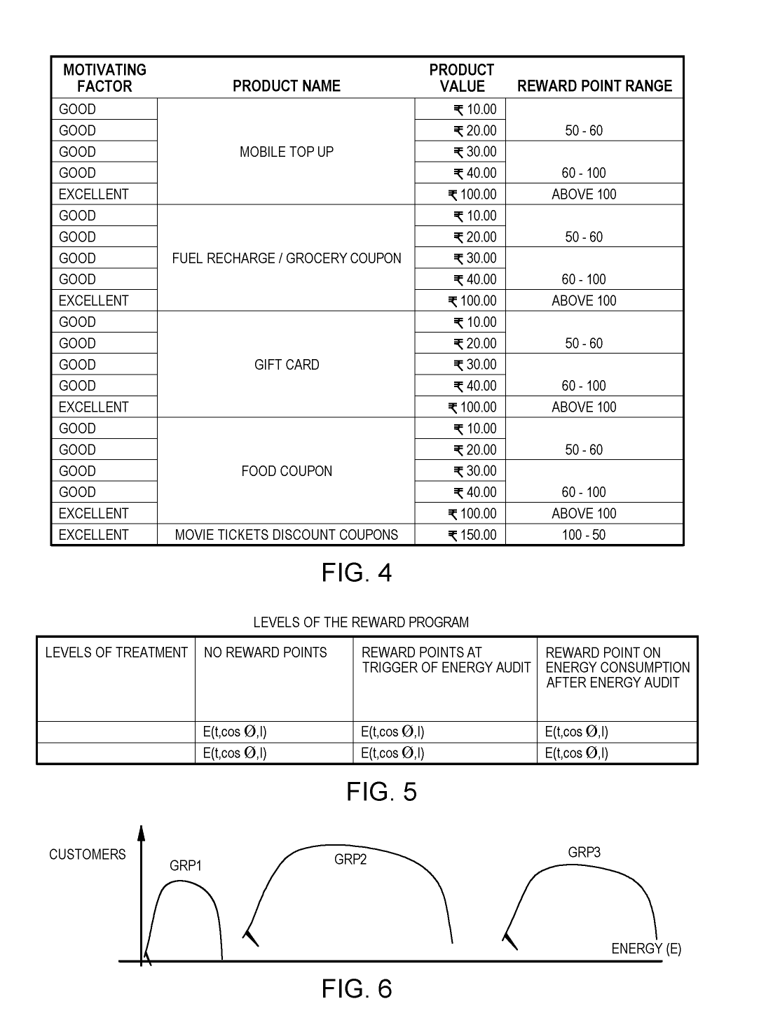

FIG. 4 shows the motivation level of each product.

Section (E)

This section discusses checking whether it is advisable to continue giving rewards to a customer, based on a comparison of that customer to other customers who did not get an award or other control groups. Hence, over the historical period of three years, a check is made to determine if the reward program is actually motivating the customers to save energy. This can be achieved using ANOVA testing.

FIG. 5 shows levels, or categories, of reward points. In the first level, no reward points are awarded. In a second level, reward points are given when an energy audit is triggered. In a third level, reward points are given based on energy consumption after the energy audit.

The one-way analysis of variance (ANOVA) is used to determine whether there are any statistically significant differences between the means of three or more groups who are rewarded or not rewarded for reducing energy consumption. ANOVA testing is used because the energy consumption values across customers in each group follows a normal/Gaussian distribution.

As an example, the energy consumption patterns for different groups of customers that are treated differently, and in particular, that received different levels of rewards, including a control group that received no rewards. may be as shown in FIG. 6.

The diagram of FIG. 6 is just for exemplification.

Ideally, in an example case, energy consumption and customers are random discrete variables with equal weight. Hence, for a group of customers:

$$μ = \frac{1}{n} {\sum }^{n} xi \\ Variance = \frac{1}{n} {\sum }^{n} ( xi - μ ) SQR \qquad Equation ( 6 )$$

where n is the number of customers in the group, and μ is equal to the group mean/mean of the customers in the group.
The example of FIG. 6 shows three groups of customers. The number of groups can be represented as k. A Null Hypothesis (H0) is that all three customer treatments shown in FIGS. 5 and 6 have no impact on energy consumed. If the one-way ANOVA testing shows a significant result, an alternative hypothesis (H_{A}) can be accepted that there are at least two group means that are statistically significantly different from each other.

One alternate hypothesis, Hypothesis 1, is that reward points motivate customers to save energy, i.e., reward point treatments have an impact on energy consumption.

Variance=variance between the mean of the three samples/Variance internally between each sample Equation (7).

For n degrees of freedom, in case the variance is greater than a specified rejection, or threshold, value, the null hypothesis can be rejected, and the rewards program can continue giving the reward points to the customer.

This will ensure that rewards are useful enough to motivate the customers. In case rewards are not motivating enough to the customers, the utility can discontinue or withdraw the awards program.

Steady State Analysis of Consumers' Behavior Due to Reward Points

This section illustrates how the energy distribution utility could predict an initial state risk category, a transient state risk category, and final state risk category for their customers.

With embodiments of the invention, there will be a probability that although a customer may have an energy audit performed, or leverage renewable sources of energy to decrease his energy bill, the customer will still increase his energy consumption by either buying new equipment or increasing the duration of power use. For example, after the energy audit, the customer may operate the equipment for a length of time t′>t+Δt (where Δt≤0.15t). This probability is denoted by a random probability pi. Increase in time duration means there would be an increase in energy consumption.

The remaining low risk population has 1-pi probability to continue low power consumption. Similarly, after reward points are given for energy audit/energy savings, let p2 be the probability that the customer continues to be a high risk customer. There is thus a 1-p2 probability that the customer will change to a low risk customer.

Similarly, there is a probability, p3, that some low risk customers (after seeing the benefits of an energy audit), may increase their consumption beyond 0.15eo and become high risk customers. The remaining low risk customers will have (1-p3) probability to remain low risk customers.

Final Sate Probability:

$$V = [ \begin{matrix}1 & 1 - pi \\ & \end{matrix} ] * [ \begin{matrix}p 2 i & 1 - p 2 i \\ p 3 i & 1 - p 3 i\end{matrix} ] \qquad Equation ( 8 )$$

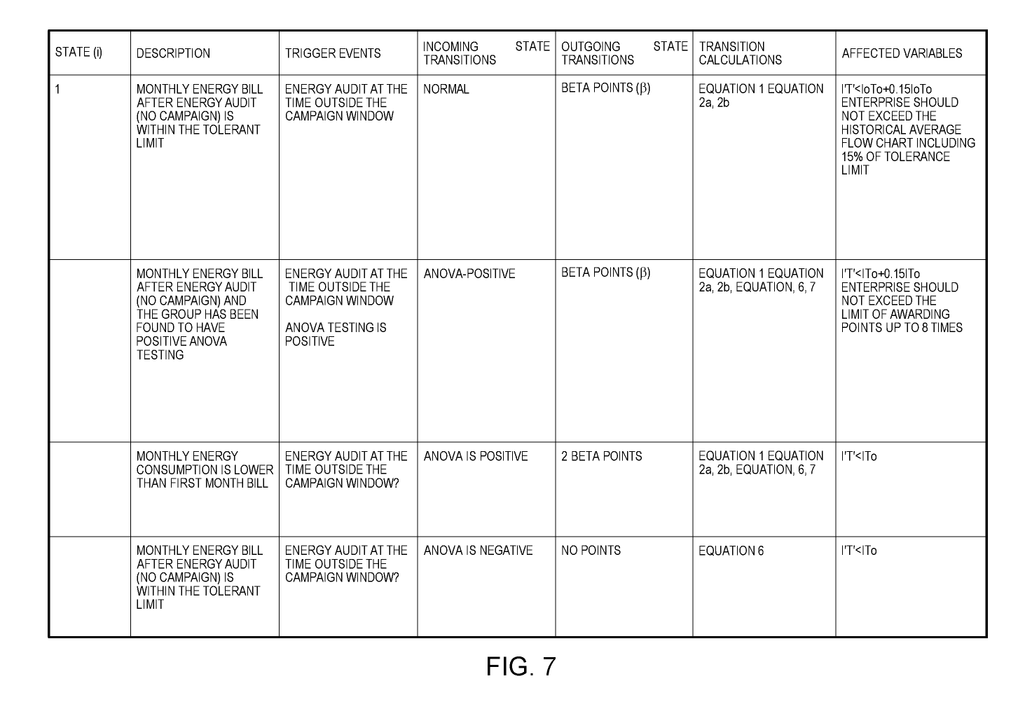

FIG. 7 is a table that shows several states of a customer; and for each of these states, the table shows triggering events, identifies transition calculations, and identifies affected variables.

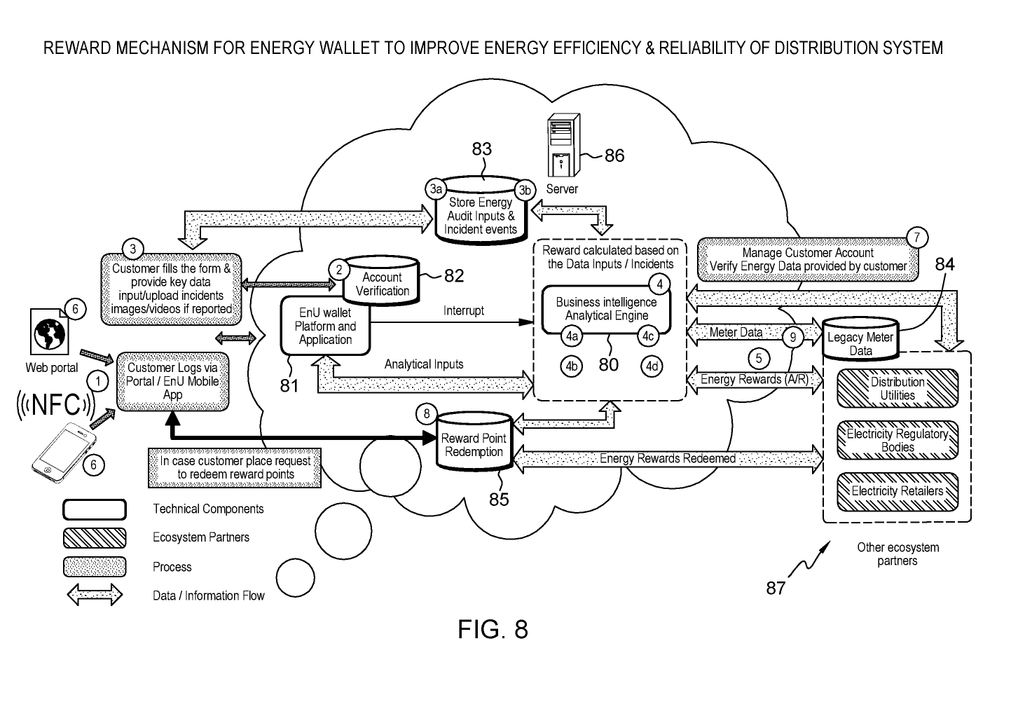

FIG. 8 shows an architecture for a system in accordance with an embodiment of the invention. Generally, this architecture shows a Business Intelligence and Analytical Engine 80, an EnU wallet platform and application 81, Account Verification component 82, Store Energy Audit Inputs and incident Events component 83, Legacy Meter Data store, Reward Point Redemption component 85, file server 86, and Ecosystem Partners 87. The algorithm explained in the above-discussed sections A, B, C, D, and E is stored in the Business Analytics Engine. This Engine invokes several process steps, discussed below. The algorithm needed by the Engine is created using the above-discussed equations 1, 2, 3, 4, 5 and 6.

Reward Platform 85 stores and displays necessary events in a mobile computing device. This Platform is the back end support for a mobile application. Ecosystem Partners 87 are other entities who are partners in the reward creation and distribution of reward points. While reward points are created by utilities, point consumption, or use of those points, is dependent on other system partners like retailers, multi-brand outlets and regulatory bodies.

At step 1 of this process, a customer opens a mobile application (through a front end widget) which is connected to their mobile wallet platform (in a cloud environment), or the customer logs into a platform via a web portal. At step 2, the customer account is verified. Upon verification, the customer is able to login into a portal or a mobile app. At step 3, an energy audit is performed by a third party, or the energy distribution utility company performs an energy audit on behalf of the customer once the customer makes the payment for the energy audit.

At step 4, the Business Intelligence and Analytical Engine 80 receives the stored data from the file server 86. This data has legacy meter data. The reward algorithms/use cases are stored in this file server, and the use cases are run based on the customer data inputs. Four key scenarios to be considered independently for reward calculation are discussed below.

At 4a, the consumer asks for the energy audit at a time of the consumer's preference—i.e., when the energy distribution utility is not running an energy audit campaign. At 4b, the customer asks for an energy audit at a time when the energy distribution utility is running a campaign to optimize energy saving. At 4c, the customer saves energy without an energy audit by virtue of reduced electricity consumption. At 4d, the customer reports a hazardous or safety related issue such as frayed or worn wires.

At step 5, the Analytical Engine 81 provides output indicating whether reward points should be given or not. The data go to the energy distribution utility companies for final approval (approved/rejected). At step 6, once reward points are approved by the appropriate regulatory authority, those points are reflected in the customer account. The customer can view the reward points credited in the account. A reward history is maintained. All the reward points are accumulated in the customer account based on the energy savings. As represented by step 7, all the customer accounts are managed by the energy distribution utility companies in conjunction with energy retailers such as electricity retailers. The distribution companies verify the energy data and accordingly approve/reject the reward points.

At step 8, in case the customer wants to place a request to redeem reward points, the customer can place this request via the EnU wallet or the web portal. The request is processed using the point creation and redemption table. Based on the pre-checks defined in the points redemption table, that table indicates whether the customer is or is not eligible for point redemption. If the customer is eligible, then points are redeemed by awarding the customer with a particular product. It is important, in embodiments of the invention, that the value of the product is based on the number of reward points. This becomes a motivating factor for a customer to get more reward points to get the highest value product. As represented at step 9, meter data for different customers is analyzed. Meter data may be extracted from the legacy data from the utility.

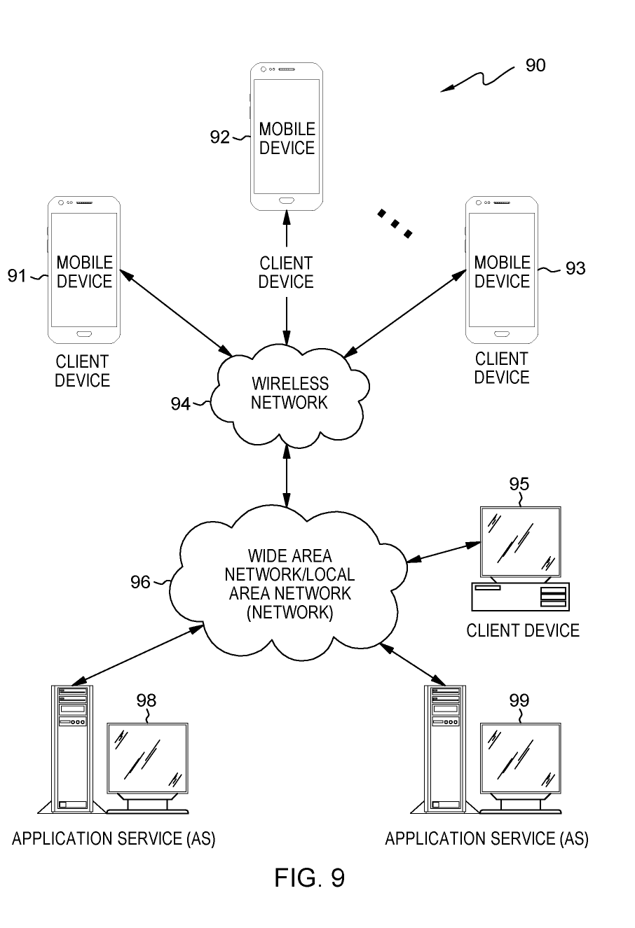

FIG. 9 shows components of an exemplary computer network environment 90 that may be used in embodiments of the invention. Not all the illustrated components may be required to practice the invention, and variations in the arrangement and type of the components may be made without departing from the spirit or scope of the invention. As shown, system 90 of FIG. 9 includes local area networks (“LANs”)/wide area network 96, wireless network 90, mobile devices 91-93, client device 95, and application services (AS) 98-99.

Generally, mobile devices 91-93 may include virtually any portable computing device that is capable of receiving and sending a message over a network, such as networks 96 and wireless network 94. Such devices include portable devices, such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 91-93 typically range widely in terms of capabilities and features.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 91-93 may each receive messages sent from AS 98-99, from one of the other mobile devices 91-93, or even from another computing device. Mobile devices 91-93 may also send messages to one of AS 98-99, to other mobile devices, or to client device 95, or the like. Mobile devices 91-93 may also communicate with non-mobile client devices, such as client device 95, or the like.

Wireless network 94 is configured to couple mobile devices 91-93 and its components with network 96. Wireless network 94 may include any of a variety of wireless sub-networks that may further overlay stand-alone ad-hoc networks, and the like, to provide an infrastructure-oriented connection for mobile devices 91-93. Such sub-networks may include mesh networks, Wireless LAN (WLAN) networks, cellular networks, and the like.

Network 96 is enabled to employ any form of computer readable media for communicating information from one electronic device to another. Also, network 96 can include the Internet in addition to local area networks (LANs), wide area networks (WANs), direct connections, such as through a universal serial bus (USB) port, other forms of computer-readable media, or any combination thereof.

AS 98-99 include virtually any device that may be configured to provide an application service. Such application services or simply applications include, but are not limited to, email applications, search applications, video applications, audio applications, graphic applications, social networking applications, text message applications, or the like. In one embodiment, AS 98-99 may operate as a web server. However, AS 108-109 are not limited to web servers.

Those of ordinary skill in the art will appreciate that the architecture and hardware depicted in FIG. 9 may vary.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of rewarding customers for sustained energy conservation, the method comprising:
establishing a baseline of energy consumption for a customer based on energy consumption of the customer over a given period of time;
defining a rewards program for energy conservation; and
determining a reward for the customer, based on the defined rewards program, for maintaining the customer's energy utilization, over a defined time duration after said given period of time, in a given range compared to said baseline of energy consumption.

2. The method according to claim 1, wherein the establishing a baseline of energy consumption is done after an energy audit is performed of the customer's energy use.

3. The method according to claim 2, wherein the energy audit is performed by an energy distribution utility that distributes energy to the customer.

4. The method according to claim 2, wherein the energy audit is performed by the customer.

5. The method according to claim 1, wherein the baseline of energy consumption is a defined minima of energy consumption during a specified time within the given period of time.

6. The method according to claim 1, wherein the determining a reward for the customer includes rewarding the customer for maintaining a defined optimum utilization of energy over the defined time duration.

7. The method according to claim 1, wherein the rewards program rewards consumers for energy consumption across a plurality of different use cases.

8. The method according to claim 7, wherein the plurality of different use cases includes a case having a spike increase of energy consumption compared to a defined historical average.

9. The method according to claim 7, wherein the plurality of use cases includes:
a first case in which the customer performs an energy audit, based on a specified set of equipment, and the customer does not obtain any additional equipment after the energy audit for said specified set of equipment; and
a second case in which the customer has an energy audit performed during a window period set by an energy distribution utility that distributes the energy to the customer.

10. The method according to claim 1, further comprising:
identifying a first, reward user group of customers that are rewarded for energy conservation by using the defined energy rewards program;
identifying a second, non-reward user group of customers that are not rewarded for energy conservation by using the defined rewards program; and wherein each of the reward user group and the non-reward group of customers has a respective specified energy consumption;
testing the efficacy of the rewards program by comparing the specified energy consumption of the reward user group with the specified energy consumption of the non-reward user group.

11. A system for rewarding customers for sustained energy conservation, the system comprising:
a memory for storing data; and
one or more processing units operatively connected to the memory and configured to operate as:
a file server for receiving specified energy consumption data from customers; and
a business intelligence analytical engine storing a defined rewards program for energy conservation; establishing a baseline of energy consumption for one of the customers over a given period of time; and determining a reward for the one customer, based on the defined rewards program, for maintaining the one customer's energy utilization, over a defined time duration after said given period of time, in a given range compared to said baseline of energy consumption.

12. The system according to claim 11, wherein the establishing a baseline of energy is done after an energy audit is performed of the one customer's energy use.

13. The system according to claim 11, wherein the baseline of energy consumption is a defined minima of energy consumption during a specified time within the given period of time.

14. The system according to claim 11, wherein the determining a reward for the one customer includes rewarding the one customer for maintaining a defined optimum utilization of energy over the defined time duration.

15. The system according to claim 11, wherein:
a first group of the customers are a reward user group of customers that are rewarded for energy conservation by using the defined energy rewards program;
a second group of the customers are a non-reward user group of customers that are not rewarded for energy conservation by using the defined rewards program; and wherein each of the reward user group and the non-reward group of customers has a respective specified energy consumption; and
the business intelligence analytical engine testing the efficacy of the rewards program by comparing the specified energy consumption of the reward user group with the specified energy consumption of the non-reward user group.

16. A computer program product for rewarding customers for sustained energy conservation, the computer program product comprising:
a computer readable storage medium having program instructions embodied therein, the program instructions executable by a computer to cause the computer to perform the method of:
establishing a baseline of energy consumption for a customer over a given period of time;
defining a rewards program for energy conservation; and
determining a reward for the customer, based on the defined rewards program, for maintaining the customer's energy utilization, over a defined time duration after said given period of time, in a given range compared to said baseline of energy consumption.

17. The computer program product according to claim 16, wherein the establishing a baseline of energy consumption is done after an energy audit is performed of the customer's energy use.

18. The computer program product according to claim 16, wherein the baseline of energy consumption is a defined minima of energy consumption during a specified time within the given period of time.

19. The computer program product according to claim 16, wherein the determining a reward for the customer includes rewarding the customer for maintaining a defined optimum utilization of energy over the defined time duration.

20. The computer program product according to claim 16, wherein:
a first group of customers are a reward user group of customers that are rewarded for energy conservation by using the defined energy rewards program;
a second group of customers are a non-reward user group of customers that are not rewarded for energy conservation by using the defined rewards program; and wherein each of the reward user group and the non-reward group of customers has a respective specified energy consumption; and
the method further comprises testing the efficacy of the rewards program by comparing the specified energy consumption of the reward user group with the specified energy consumption of the non-reward user group.
